(19) United States
(12) Patent Application Publication
(10) Pub. No.: US 2009/0220097 A1
(43) Pub. Date: Sep. 3, 2009

(54) SOUND TESTING DEVICE FOR MOBILE PHONE AND METHOD FOR USING THE SAME

(75) Inventors: WEN-CHIEH KUO, Tu-Cheng (TW); CHIANG-FU PAN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: Chi Mei Communication Systems, Inc., Tu-Cheng City (TW)

(21) Appl. No.: 12/170,529

(22) Filed: Jul. 10, 2008

(30) Foreign Application Priority Data
Feb. 29, 2008 (CN) 200810300434.8

(51) Int. Cl. H04R 29/00

(52) U.S. Cl. 381/58

(57) ABSTRACT

A sound testing device (100) includes a processor (10), a mouth simulator (30), an ear simulator (40) and a soundproof container (50). The processor includes a first testing module (131) for test sound components which transform sound signals into electronic signals, a second testing module (132) for test sound components which transform electronic signals into sound signals, and a controlling module (12) connected to the first testing module and the second testing module. The mouth simulator is connected to the processor and sends sound signals input into test sound components. The ear simulator is connected to the processor and receives sound signals output from test sound components. The soundproof container receives the mouth simulator and the ear simulator therein.

### BACKGROUND OF THE INVENTION

1. Field of the Invention

The present invention generally relates to sound testing devices for mobile phones and sound testing methods, particularly to an automatic sound testing device for mobile phones and a method for using the same.

2. Description of Related Art

In manufacturing of mobile phones, it is necessary to test the sound quality of many components, such as microphones, earphones and speakers. In most typical testing methods, sound characteristics of these components, such as the maximal value of frequency response, the acceptable total harmonic distortion (THD) and rub and buzz distortion, are recorded and displayed by oscillographs. The components are evaluated based on the testing results.

However, analyzing the test results is generally time consuming. In production, the number of the test sound components is usually very large. Thus, displaying initial test results of sound characteristics of the components and analyzing the test result to test the components may spend too much time, thereby delaying the producing procedure.

Therefore, a new sound testing device and a new testing method are desired in order to overcome the above-described shortcomings.

### BRIEF DESCRIPTION OF THE DRAWINGS

Many aspects of the new testing device and method for using the same can be better understood with reference to the following drawings. The components in the drawings are not necessarily drawn to scale, the emphasis instead being placed upon clearly illustrating the principles of the new testing device and method for using the same. Moreover, in the drawings, like reference numerals designate corresponding parts throughout the several views.

FIG. 1 is a diagram of a sound testing device, according to an exemplary embodiment.

FIG. 2 is a flow chart of a testing method according to a first exemplary embodiment, which is used to test a sound component transforming electronic signals into sound signals.

FIG. 3 a flow chart of a testing method according to a second exemplary embodiment, which is used to test an sound component transforming sound signals into electronic signals.

### DETAILED DESCRIPTION OF THE INVENTION

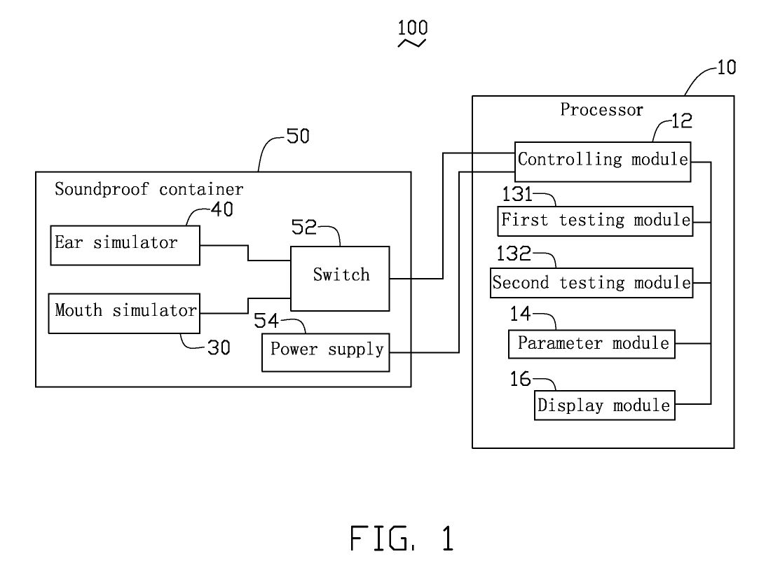

Referring to FIG. 1, a sound testing device 100 according to an exemplary embodiment is shown. The sound testing device 100 tests the quality of sound components of mobile phones, such as microphones, earphones and speakers, etc. The sound testing device 100 includes a processor 10, a mouth simulator 30, an ear simulator 40 and a soundproof container 50.

The processor 10 can be a personal computer or a single chip, etc., which is configured for controlling the mouth simulator 30 to send sound signals to test sound components and receive sound signals detected by the ear simulator 40 to test sound components of mobile phones. The processor 10 includes a controlling module 12, a first testing module 131, a second testing module 132, a parameter module 14 and a display module 16. The controlling module 12 is electronically connected to the first testing module 131, the second testing module 132, the parameter module 14 and the display module 16 to control the testing process, and particularly to provide electronic testing signals to the test sound components. The first testing module 131 receives and analyzes electronic signals, from test sound components which transform sound signals into electronic signals, such as microphones. The second testing module 132 receives and analyzes sound signals, from test sound components which transform electronic signals into sound signals, such as earphones or speakers. Both the first testing module 131 and the second testing module 132 have a fast Fourier transform algorithm (FFT) program installed therein. The parameter module 14 is configured for setting and storing testing parameters. The display module 16 is a screen configured for displaying relative testing data and test results.

The mouth simulator 30 generates sound signals received by test sound components. The ear simulator 40 receives sound signals output from test sound components. The soundproof container 50 receives the mouth simulator 30, the ear simulator 40 and test sound components therein to prevent outside sound signals from interfering with the testing process. The soundproof container 50 includes a switch 52 and a power supply 54. Both the mouth simulator 30 and the ear simulator 40 are electronically connected to the processor 10 via the switch 52. Thus, the mouth simulator 30 and the ear simulator 40 are selectively connected to the processor 10. The power supply 54 is configured for providing power to the test sound components during testing process.

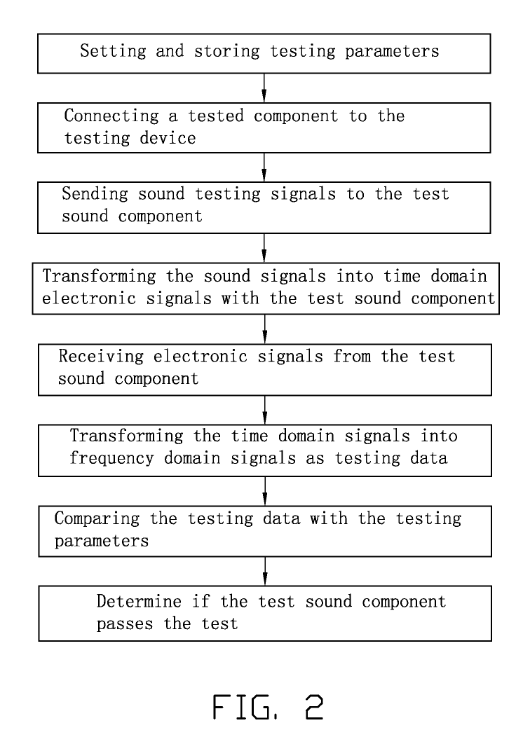

Referring to FIG. 2, a method for testing sound component quality, according to a first exemplary embodiment, is shown.

First, testing parameters are set and stored in the parameter module 14 of the processor 10. The testing parameters are acceptable ranges of relative parameters which indicate sound quality of the test sound components, for example, the value of frequency response, the allowable total harmonic distortion (THD), rub and buzz, etc.

Second, connecting the test sound component to the testing device 100. A test sound component is placed in the soundproof container 50, and electronically connected to the power supply 54 and the processor 10.

Third, sound quality of the component is test. The controlling module 12 of the processor 10 controls the switch 52 to turn on the power supply 54 and the mouth simulator 30. Whereafter, the controlling module 12 controls the mouth simulator 30 to send sound testing signals to the test sound component, and the test component transforms the sound signals into electronic signals. Understandably, the electronic signals directly outputted from the test sound component are time domain signals.

The first testing module 131 is then activated and receives the time domain electronic signals outputted from the test component, and transforms the time domain electronic signals into frequency domain electronic signals by the FFT program installed therein. It is understood that some important parameters which indicate quality of sound components, such as frequency response, THD and rub and buzz, can be shown more distinctly in frequency domain than in time domain. The frequency domain electronic signals are regarded as testing data and compared with the stored testing parameters. If the testing data does not exceed an acceptable range determined by the testing parameters, the test sound component passes the test. On the other hand, if the testing data of a test sound component exceeds the acceptable range of the testing parameters, the test component fails the test. The display module 16 can display the testing data and the comparing results.

In the testing method according to the first embodiment, the controlling module 12 can also control the mouth simulator 30 to send sound signals in different frequencies to the test sound component, and then the first testing module 131 analyses the electronic signals outputted from the test sound component having different frequencies to improve test precision.

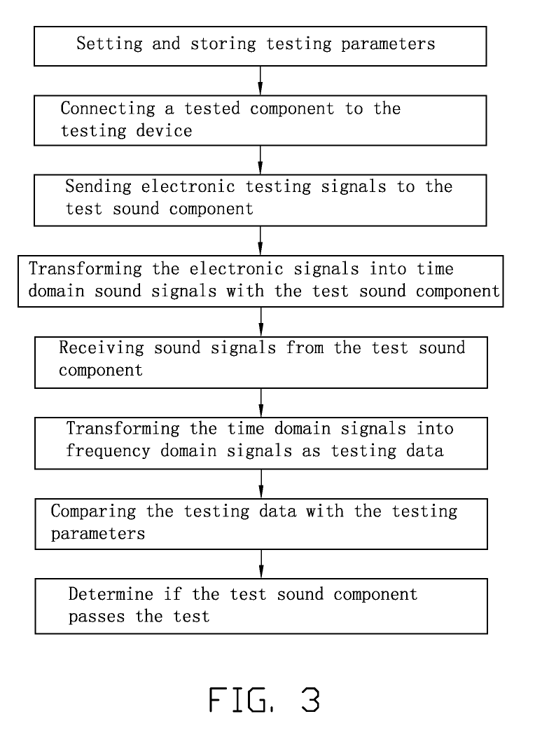

Referring to FIG. 3, a method for testing quality of sound components, according to a second exemplary embodiment, is shown. This method is essentially using the testing device 100 to test sound components which transform electronic signals into sound signals, such as earphones or speakers. The method includes these steps.

First, setting and storing parameters and connecting the test sound component to the testing device 100, which are similar to that of the method according to the first embodiment, are performed.

Second, the sound quality of the component is tested. The controlling module 12 controls the switch 52 to turn on the power supply 54 and the ear simulator 40. Whereafter, the controlling module 12 sends electronic testing signals to the test component. The test component transforms the electronic signals into sound signals, thus the controlling module 12 controls the ear simulator 30 to receive sound signals outputted from the test component, and transform the sound signals into electronic signals. Understandably, the electronic signals sound signals directly outputted from the test component are time domain signals.

Similar to the first testing module 131, the second testing module 132 is activated and receives the time domain electronic signals transformed from the sound signals received by the ear simulator 40, and further transforms the time domain electronic signals into frequency domain electronic signals by the FFT program installed therein. The frequency domain electronic signals are regarded as testing data and compared with the stored testing parameters. If the testing data of a test sound component does not exceed an acceptable range determined by the testing parameters, the test component passes the test. On the other hand, if the testing data of a test sound component exceeds the acceptable range, the test component fails the test. The display module 16 can display the testing data and the comparing results.

In the testing method according to the second exemplary embodiment, the controlling module 12 can also send electronic signals in different frequencies to the test component and controls the ear simulator 40 to receive sound signals outputted from the test component having different frequencies. The second testing module 132 then analyses the sound signals to improve test precision.

Compared to most typical sound testing devices, the present testing device 100 is simple in structure and cost less. Compared to most typical sound testing methods, the present testing methods need not directly displaying test results of the sound characteristics of test sound components, and analyzes signals in frequency domain; which simplifies testing procedure and allows the testing data and testing results to have a higher precision.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A sound testing device, comprising:
a processor including a first testing module for test sound components which transform sound signals into electronic signals, a second testing module for test sound components which transform electronic signals into sound signals, and a controlling module connected to the first testing module and the second testing module;
a mouth simulator connected to the processor and configured for sending sound signals to test sound components;
an ear simulator connected to the processor and configured for receiving sound signals output from test sound components; and
a soundproof container containing the mouth simulator and the ear simulator therein.

2. The sound testing device as claimed in claim 1, wherein the processor includes a parameter module connected to the controlling module for setting and storing testing parameters.

3. The sound testing device as claimed in claim 1, wherein the processor includes a display module connected to the controlling module for displaying testing data and testing results.

4. The sound testing device as claimed in claim 1, wherein the soundproof container includes a switch, the mouth simulator and the ear simulator being connected to the switch and selectively connected to the processor via the switch.

5. The sound testing device as claimed in claim 1, wherein the soundproof includes a power supply configured for providing power to test sound components.

6. An testing method for testing sound components, comprising:
providing a testing device;
setting and storing testing parameters in the testing device;
connecting a test component to the testing device;
sending electronic testing signals or sound testing signals to the test component using the testing device;
transforming the electronic signals into sound signals, or transforming the sound signals into electronic signals with the test component;
receiving electronic signals or sound signals from the test component, and transforming these signals into frequency domain signals as testing data with the testing device; and
comparing the testing data with the testing parameters to determine if the test component passes the test.

7. The testing method as claimed in claim 6, further comprising: using a processor configured for setting and storing testing parameters to provide electronic testing signals to the test component.

8. The testing method as claimed in claim 7, further comprising using a mouth simulator for providing sound signals to the test component and an ear simulator for receiving sound signals from the test component, and positioning the mouth simulator and the ear simulator in a soundproof container.

9. The testing method as claimed in claim 8, wherein both the mouth simulator and the ear simulator are connected to the processor.

10. The testing method as claimed in claim 8, wherein the step of connecting a test component to the testing device includes:
receiving the test component in the soundproof container; and
connecting the test component to the processor.

11. The testing method as claimed in claim 7, further comprising using a first testing module for test sound components which transform sound signals into electronic signals, and using a second testing module for test sound components which transform electronic signals into sound signals.

12. The testing method as claimed in claim 11, further comprising:
activating the first testing module when the test component transforms sound signals into electronic signals; or
activating the second testing module when the test component transforms electronic signals into sound signals.
